(19) United States
(12) Patent Application Publication
(10) Pub. No.: US 2008/0223183 A1
(43) Pub. Date: Sep. 18, 2008

(54) Ergonomically Improved Universal Valve Key Tool

(76) Inventors: Robert Clodfelter, Castle Rock, CO (US); Glenn Scott Oelkers, Sedalla, CO (US)

Correspondence Address: Scott Oelkers, 2737 Big Bear Drive, Sedalia, CO, 80135, US

(21) Appl. No.: 11/686,554

(22) Filed: Mar. 15, 2007

(51) Int. Cl. B25B 23/16

(52) U.S. Cl. 81/177.1; 81/52

(57) ABSTRACT

This Ergonomically Improved Universal Valve Key Tool is used to open and close gate valves and ball valves within water and gas distribution systems. The valve key tool may be any length, made of strong material such as steel pipe. The valve key tool is manually operated, has no gas powered motor, but, enables the user to quickly and efficiently open and close valves. One hand stays stationary on the valve key stem while the other hand spins the handle around the stationary hand. There is an additional lever handle lower on the stem which allows initial leverage in order to get the valve moving. The moving arm of the user holds onto a spinning grip, thereby allowing ease of use and speed. The key end of the tool is formed such that mud and debris surrounding the valve will be displaced through vents at the top of the key.

### BACKGROUND OF THE INVENTION

1. Field of the Invention

The present invention relates to the distribution of water and gas as utilities and more particularly pertains to the turning open and shut of valves that are in these distribution systems.

2. Description of Prior Art

The use of valve keys for water and gas distribution systems is known in the prior art. Typical examples of well designed valve keys are to be found in U.S. Pat. No. D515,372 S, by Ron O. Marston dated Feb. 21, 2006, and U.S. Pat. No. 6,364,285 B1 which is issued to Dan L. Stinnett on Apr. 2, 2002. The patent issued to Mr. Marston shows a circular handle attached to a stem of no known length which then attaches to a valve key. This design can be appreciated to show a good method for designing a valve key tool, however, using a circular handle as seen does not allow for quick opening and closing of valves.

By the same token the Stinnett patent shows another style of valve key tool that can be taken apart and assembled easily. This design is in a fashion of what the most common valve key tool is, however, the use of such a key is laborious and strainful on the human back and arms. There is certainly room for improvement from an ergonomic and human factor point of view for the design of a user friendly valve key tool. This leads the design of our ergonomically improved universal valve key tool.

### SUMMARY OF THE INVENTION

In view of the foregoing disadvantages inherent in other valve key tool designs now present in the prior art, the present invention provides an ergonomically improved valve key tool which can be used in many industries.

The basis of knowledge which created this invention came from a long time water and wastewater facility and distribution system operator, Bob Clodfelter. Bob found through experience that the old way of opening and closing gate valves and ball valves within the distribution system took too long and was hard on the back. So Bob went out to design a better tool for opening and closing these valves in a much more efficient manner.

From this need, this invention was born. This ergonomically improved valve key tool is manually operated, has no gas powered motor, but, enables the user to quickly and efficiently open and close water and gas valves. One hand stays stationary on the key stem while the other hand spins the handle around the stationary hand. There is an additional lever handle lower on the stem which allows initial leverage in order to get the valve moving. The moving arm of the user holds onto a spinning grip, thereby allowing ease of use and speed. With the appropriate key on the bottom of this tool, many types of utility valves may also be operated. One specific key, used in water distribution systems, is being claimed in this patent.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new and improved valve key tool which has all of the advantages of the prior art valve key tools and none of the disadvantages.

It is another object of the present invention to provide a new and improved valve key tool which may be easily and efficiently manufactured and marketed.

It is a further object of the present invention to provide a new and improved valve key tool which is of a durable and reliable construction.

An even further object of the present invention is to provide a new and improved valve key tool which is susceptible of a low cost of manufacture with regard to both materials and labor, and which accordingly is then susceptible of low prices of sale to the consuming public, thereby making such valve key tool economically available to the buying public.

Still yet another object of the present invention is to provide a new and improved valve key tool which provides in the apparatuses and methods of the prior art some of the advantages thereof, while simultaneously overcoming some of the disadvantages normally associated therewith.

Still another object of the present invention is to provide a new and improved valve key tool which is easier to use and provides less strain to the human body.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a foreshortened perspective view of the first embodiment of ergonomically improved valve key tool showing the present invention.

FIG. 2 is a foreshortened perspective view of the second embodiment of the invention, the grip mechanism of the valve key tool handle. The handle is shown to freely turn on an internal shaft.

FIG. 3 is a perspective view of the third embodiment of the invention, the valve key

FIG. 4 is a 90 degree turned perspective of the same valve key

### DESCRIPTION OF THE PREFERRED EMBODIMENT

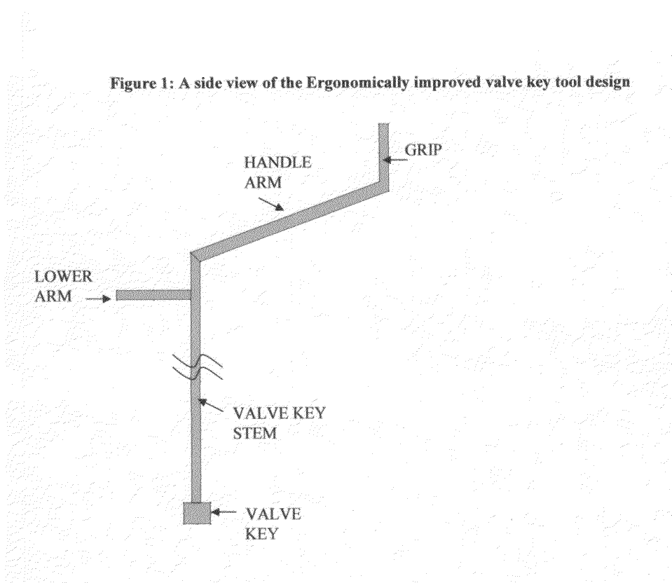

With reference now to the drawings, and in particular to FIG. 1 thereof, a new and improved valve key tool embodying the principles and concepts of the present invention will be described.

FIG. 1 shows the complete embodiment of the invention. The valve key tool in the picture shows the handle arm and the grip rising from the handle arm. Generally speaking the material used in this invention contains, but, is not limited to steel pipe or tubing. As in previous art, the tubing might be square in the area of the key stem.

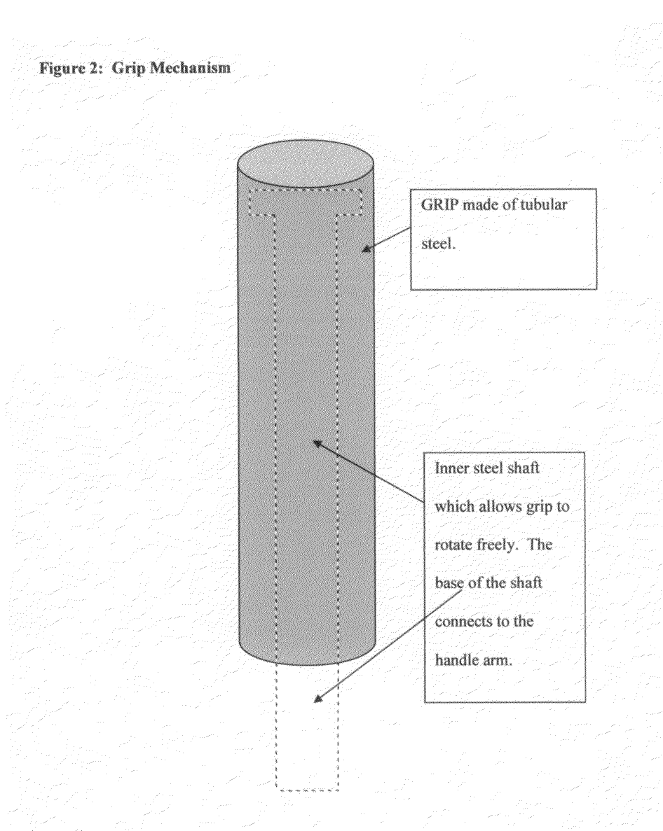

FIG. 2 shows the embodiment of the grip. The grip will be comprised of, but, not limited to, a section of steel pipe freely spinning on an internal shaft. The internal shaft is connected to the handle arm.

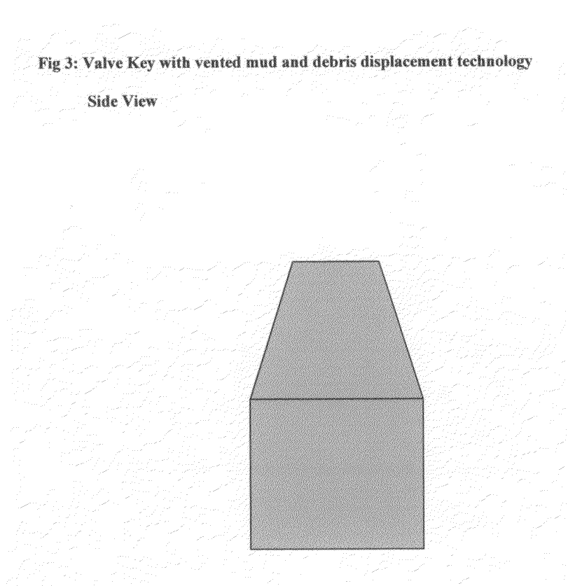

FIG. 3 shows the embodiment of the valve key. This valve key is generally made from, but, not limited to steel square tubing welded to a cut and bent piece of sheet metal. The sheet metal should have a similar thickness to the steel square tubing. The completed assembly of the valve key shall then be welded to the base of the valve key stem.

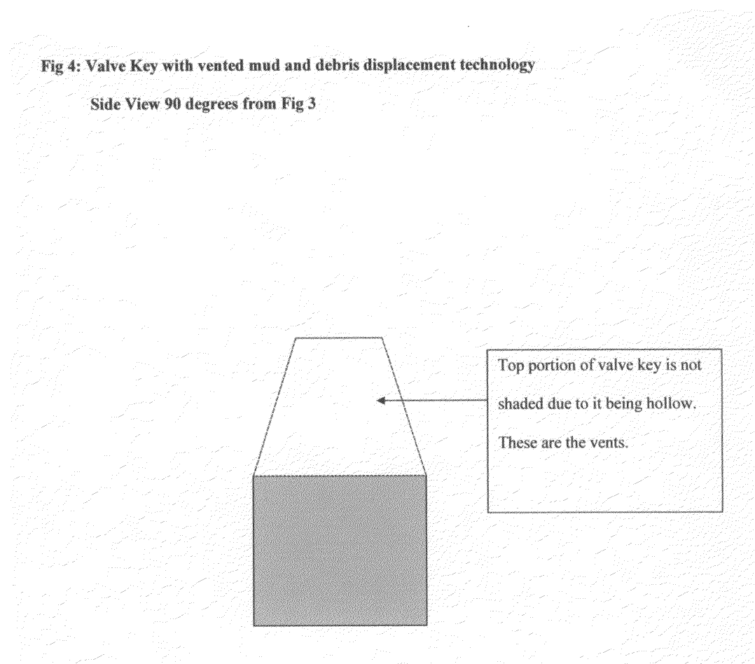

FIG. 4 shows the embodiment of the valve key turned 90 degrees showing how the top portion of the key is vented to allow for mud and debris to disperse.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed as being new and desired to be protected by Letters Patent of the U.S. is as follows:

1) A new and improved handle for use in a valve key tool, used for water, fluid or gas valves comprised of:
a. a first length of pipe or tubing (handle arm) connected to the top of the valve key stem at an angle of 90 to 135 degrees with the valve key stem
b. a second length of pipe or tubing (grip) connected via a shaft to the handle arm extending vertical in parallel with the valve key stem
c. the grip is mounted on a vertical shaft and freely rotates around the vertical shaft
d. the vertical shaft is hard connected to the handle arm
e. a lower arm connected to the valve key stem which allows more torque to be placed on the valve key stem

2) A new and improved key at the base of the key stem allowing mud and debris to vent vertically through the top of the key when downward pressure is applied by the user to set the key onto a valve

3) Utilizing a pantone color of, (hexadecimal) 99FA00, yield sign color for safety, to paint the ergonomically improved valve key so that vehicles will easily and readily identify our valve key if it is left in an area where the vehicle might collide with the valve key.
